(19) United States
(12) Patent Application Publication
(10) Pub. No.: US 2021/0042954 A1
(43) Pub. Date: Feb. 11, 2021

(54) BINOCULAR MATCHING METHOD AND APPARATUS, DEVICE AND STORAGE MEDIUM

(71) Applicant: BEIJING SENSETIME TECHNOLOGY DEVELOPMENT CO., LTD., Beijing (CN)

(72) Inventors: Xiaoyang GUO, Beijing (CN); Kai Yang, Beijing (CN); Wukui Yang, Beijing (CN); Hongsheng Li, Beijing (CN); Xiaogang Wang, Beijing (CN)

(21) Appl. No.: 17/082,640

(22) Filed: Oct. 28, 2020

Related U.S. Application Data
(63) Continuation of application No. PCT/CN2019/108314, filed on Sep. 26, 2019.

(30) Foreign Application Priority Data
Feb. 19, 2019 (CN) 201910127860.4

(51) Int. Cl. G06T 7/593; G06K 9/62

(52) U.S. Cl. CPC G06T 7/593; G06K 9/6202; G06T 2207/20084; H04N 13/239; G06T 2207/10012; G06T 2207/20081; G06T 2207/20076

(57) ABSTRACT

Embodiments of the present application disclose a binocular matching method, including: obtaining an image to be processed, where the image is a two-dimensional (2D) image including a left image and a right image; constructing a three-dimensional (3D) matching cost feature of the image by using extracted features of the left image and extracted features of the right image, where the 3D matching cost feature includes a group-wise cross-correlation feature, or includes a feature obtained by concatenating the group-wise cross-correlation feature and a connection feature; and determining the depth of the image by using the 3D matching cost feature. The embodiments of the present application also provide a binocular matching apparatus, a computer device, and a storage medium.

### CROSS-REFERENCE TO RELATED APPLICATION

The present application is a continuation of International Application No. PCT/CN2019/108314, filed on Sep. 26, 2019, which claims priority to Chinese Patent Application No. 201910127860.4, filed with the Chinese Patent Office on Feb. 19, 2019 and entitled “BINOCULAR MATCHING METHOD AND APPARATUS, DEVICE AND STORAGE MEDIUM”. The contents of International Application No. PCT/CN2019/108314 and Chinese Patent Application No. 201910127860.4 are hereby incorporated by reference in their entireties.

### TECHNICAL FIELD

Embodiments of the present application relate to the field of computer visions, and relate to, but are not limited to, a binocular matching method and apparatus, a device, and a storage medium.

### BACKGROUND

Binocular matching is a technique for restoring depth from a pair of pictures taken at different angles. In general, each pair of pictures is obtained by a pair of left-right or up-down cameras. In order to simplify the problem, the pictures taken by different cameras are corrected so that the corresponding pixels are on the same horizontal line when the cameras are placed left and right, or the corresponding pixels are on the same vertical line when the cameras are placed up and down. In this case, the problem becomes estimation of the distance (also known as the parallax) of corresponding matching pixels. The depth is calculated by means of the parallax, and the distance between the camera's focal length and the center of two cameras. At present, binocular matching is approximately divided into two methods, i.e., an algorithm based on traditional matching cost and an algorithm based on deep learning.

### SUMMARY

Embodiments of the present application provide a binocular matching method and apparatus, a device, and a storage medium.

The technical solutions of the embodiments of the present application are implemented as follows.

In a first aspect, the embodiments of the present application provide a binocular matching method, including: obtaining an image to be processed, where the image is a two-dimensional (2D) image including a left image and a right image; constructing a three-dimensional (3D) matching cost feature of the image by using extracted features of the left image and extracted features of the right image, where the 3D matching cost feature includes a group-wise cross-correlation feature, or includes a feature obtained by concatenating the group-wise cross-correlation feature and a connection feature; and determining the depth of the image by using the 3D matching cost feature.

In a second aspect, the embodiments of the present application provide a training method for a binocular matching network, including: determining, by a binocular matching network, a 3D matching cost feature of an obtained sample image, where the sample image includes left image and right image with depth annotation information, the left image and right image are the same in size; and the 3D matching cost feature includes a group-wise cross-correlation feature, or includes a feature obtained by concatenating the group-wise cross-correlation feature and a connection feature; determining, by the binocular matching network, a predicted parallax of the sample image according to the 3D matching cost feature; comparing the depth annotation information with the predicted parallax to obtain a loss function of binocular matching; and training the binocular matching network by using the loss function.

In a third aspect, the embodiments of the present application provide a binocular matching apparatus, including: an obtaining unit, configured to obtain an image to be processed, where the image is a two-dimensional (2D) image including a left image and a right image; a constructing unit, configured to construct a 3D matching cost feature of the image by using extracted features of the left image and extracted features of the right image, where the 3D matching cost feature includes a group-wise cross-correlation feature, or includes a feature obtained by concatenating the group-wise cross-correlation feature and a connection feature; and a determining unit, configured to determine the depth of the image by using the 3D matching cost feature.

In a fourth aspect, the embodiments of the present application provide a training apparatus for a binocular matching network, including: a feature extracting unit, configured to determine a 3D matching cost feature of an obtained sample image by using a binocular matching network, where the sample image includes left image and right image with depth annotation information, the left image and right image are the same in size; and the 3D matching cost feature includes a group-wise cross-correlation feature, or includes a feature obtained by concatenating the group-wise cross-correlation feature and a connection feature; a parallax predicting unit, configured to determine a predicted parallax of the sample image by using the binocular matching network according to the 3D matching cost feature; a comparing unit, configured to compare the depth annotation information with the predicted parallax to obtain a loss function of binocular matching; and a training unit, configured to train the binocular matching network by using the loss function.

In a fifth aspect, the embodiments of the present application provide a binocular matching apparatus, including: a processor; and a memory, configured to store instructions which, when being executed by the processor, cause the processor to carry out the following: obtaining an image to be processed, wherein the image is a two-dimensional (2D) image including a left image and a right image; constructing a three-dimensional (3D) matching cost feature of the image by using extracted features of the left image and extracted features of the right image, wherein the 3D matching cost feature includes a group-wise cross-correlation feature, or includes a feature obtained by concatenating the group-wise cross-correlation feature and a connection feature; and determining the depth of the image by using the 3D matching cost feature.

In a sixth aspect, the embodiments of the present application provide a non-transitory computer readable storage medium having stored thereon a computer program, that, when being executed by a computer, cause the computer to carry out the binocular matching method above.

The embodiments of the present application provide a binocular matching method and apparatus, a device, and a storage medium. The accuracy of binocular matching is improved and the computing requirement of the network is reduced by obtaining an image to be processed, where the image is a 2D image including a left image and a right image; constructing a 3D matching cost feature of the image by using extracted features of the left image and extracted features of the right image, where the 3D matching cost feature includes a group-wise cross-correlation feature, or includes a feature obtained by concatenating the group-wise cross-correlation feature and a connection feature; and determining the depth of the image by using the 3D matching cost feature.

### BRIEF DESCRIPTION OF THE DRAWINGS

FIG. 1A is a schematic flowchart 1 for implementing a binocular matching method according to embodiments of the present application;

FIG. 1B is a schematic diagram for depth estimation of an image to be processed according to embodiments of the present application;

FIG. 2A is a schematic flowchart 2 for implementing a binocular matching method according to embodiments of the present application;

FIG. 2B is a schematic flowchart 3 for implementing a binocular matching method according to embodiments of the present application;

FIG. 3A is a schematic flowchart for implementing a training method for a binocular matching network according to embodiments of the present application;

FIG. 3B is a schematic diagram of a group-wise cross-correlation feature according to embodiments of the present application;

FIG. 3C is a schematic diagram of a connection feature according to embodiments of the present application;

FIG. 4A is a schematic flowchart 4 for implementing a binocular matching method according to embodiments of the present application;

FIG. 4B is a schematic diagram of a binocular matching network model according to embodiments of the present application;

FIG. 4C is a comparison diagram of experimental results of a binocular matching method according to embodiments of the present application and a binocular matching method in the prior art;

FIG. 5 is a schematic structural diagram of a binocular matching apparatus according to embodiments of the present application;

FIG. 6 is a schematic structural diagram of a training apparatus for a binocular matching network according to embodiments of the present application; and

FIG. 7 is a schematic diagram of a hardware entity of a computer device according to embodiments of the present application.

### DETAILED DESCRIPTION

To make the objectives, technical solutions, and advantages of embodiments of the present invention clearer, the following further describes in detail the specific technical solutions of the present invention with reference to the accompanying drawings in the embodiments of the present invention. The following embodiments are merely illustrative of the present application, but are not intended to limit the scope of the present application.

In the following description, the suffixes such as “module”, “component”, or “unit” used to represent an element are merely illustrative for the present application, and have no particular meaning per se. Therefore, “module”, “component” or “unit” may be used in combination.

In the embodiments of the present application, the accuracy of binocular matching is improved and the computing requirement of the network is reduced by using the group-wise cross-correlation matching cost feature. The technical solutions of the present application are further described below in detail with reference to the accompanying drawings and embodiments.

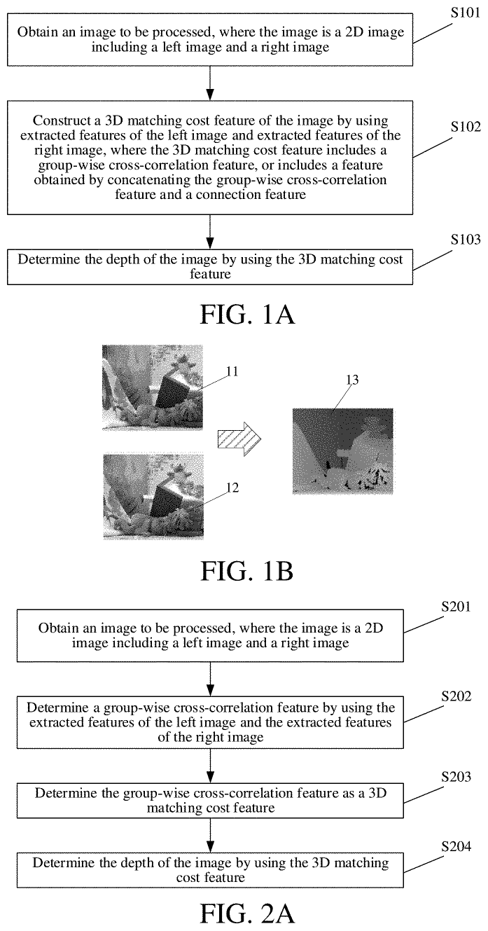

The embodiments of the present application provide a binocular matching method, and the method is applied to a computer device. The function implemented by the method may be implemented by a processor in a server by invoking a program code. Certainly, the program code may be saved in a computer storage medium. In view of the above, the server includes at least a processor and a storage medium. FIG. 1A is a schematic flowchart 1 for implementing a binocular matching method according to embodiments of the present application. As shown in FIG. 1A, the method includes the following steps.

At step S101, an image to be processed is obtained, where the image is a 2D image including a left image and a right image.

Here, the computer device may be a terminal, and the image to be processed may include a picture of any scenario. Moreover, the image to be processed is generally a binocular picture including a left image and a right image, which is a pair of pictures taken at different angles. In general, each pair of pictures is obtained by a pair of left-right or up-down cameras.

In general, the terminal is any type of device having information processing capability in the process of implementation, for example, the mobile terminal may include a mobile phone, a Personal Digital Assistant (PDA), a navigator, a digital phone, a video phone, a smart watch, a smart bracelet, a wearable device, and a tablet computer, etc. In the process of implementation, the server is a computer device having information processing capability such as a mobile terminal, e.g., a mobile phone, a tablet computer, or a notebook computer, and a fixed terminal e.g., a personal computer or a server cluster, and the like.

At step S102, a 3D matching cost feature of the image is constructed by using extracted features of the left image and extracted features of the right image, where the 3D matching cost feature includes a group-wise cross-correlation feature, or includes a feature obtained by concatenating the group-wise cross-correlation feature and a connection feature.

Here, when the 3D matching cost feature may include the group-wise cross-correlation feature, or the feature obtained by concatenating the group-wise cross-correlation feature and a connection feature, and an accurate parallax prediction result may be obtained no matter which two of the foregoing features are used to form the 3D matching cost feature.

At step S103, the depth of the image is determined by using the 3D matching cost feature.

Here, the probability of possible parallax of pixels in each left image may be determined by the 3D matching cost feature, that is, the features of pixel points on the left image and the features of the corresponding pixel points of the right image are determined by the 3D matching cost feature. That is, all possible positions on the right feature map are found by the features of one point on the left feature map, and then the features of each possible position on the right feature map are combined with the features of the point on the left map for classification to obtain the probability that each possible position on the right feature map is the corresponding point of the point on the right image.

Here, determining the depth of the image refers to determining a point corresponding to the point of the left image in the right image, and determining the horizontal pixel distance there between (when the camera is placed left and right). Certainly, it is also possible to determine a point corresponding to the point of the right image in the left image, which is not limited in the present application.

In examples of the present application, steps S102 and S103 may be implemented using a binocular matching network obtained by training, where the binocular matching network includes but is not limited to: Convolutional Neural Network (CNN), Deep Neural Network (DNN) and Recurrent Neural Network (RNN). Certainly, the binocular matching network may include one of the networks such as the CNN, the DNN, and the RNN, and may also include at least two of the network such as the CNN, the DNN, and the RNN.

FIG. 1B is a schematic diagram for depth estimation of an image to be processed according to embodiments of the present application. As shown in FIG. 1B, the picture 11 is the left picture in the image to be processed, the picture 12 is the right picture in the image to be processed, and the picture 13 is a parallax map of the picture 11 determined according to the picture 12, i.e., the parallax map corresponding to the picture 11. The depth map corresponding to the picture 11 may be obtained according to the parallax map.

In the embodiments of the present application, the accuracy of binocular matching is improved and the computing requirements of the network is reduced by obtaining an image to be processed, where the image is a 2D image including a left image and a right image; constructing a 3D matching cost feature of the image by using extracted features of the left image and extracted features of the right image, where the 3D matching cost feature includes a group-wise cross-correlation feature, or includes a feature obtained by concatenating the group-wise cross-correlation feature and a connection feature; and determining the depth of the image by using the 3D matching cost feature.

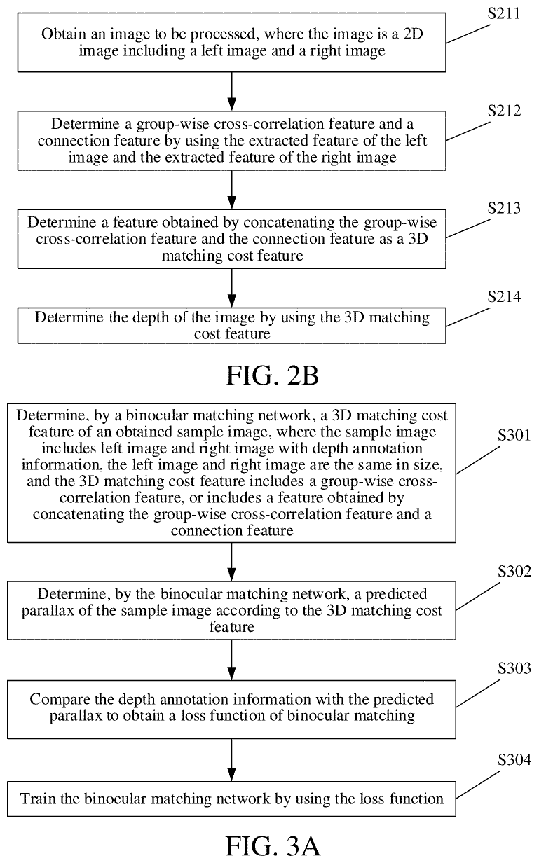

Based on the foregoing method embodiments, embodiments of the present application further provide a binocular matching method. FIG. 2A is a schematic flowchart 2 of a binocular matching method according to the embodiments of the present application. As shown in FIG. 2A, the method includes the following steps.

At step S201, an image to be processed is obtained, where the image is a 2D image including a left image and a right image.

At step S202, a group-wise cross-correlation feature is determined by using extracted features of the left image and extracted features of the right image.

In the embodiments of the present application, the step S202 of determining a group-wise cross-correlation feature by using extracted features of the left image and extracted features of the right image may be implemented by means of the following steps.

At step S2021, the extracted features of the left image and the extracted features of the right image are respectively grouped, and cross-correlation results of the grouped features of the left image and the grouped features of the right image under different parallaxes are determined.

At step S2022, the cross-correlation results are concatenated to obtain a group-wise cross-correlation feature.

The step S2021 of respectively grouping extracted features of the left image and the extracted features of the right image, and determining cross-correlation results of the grouped features of the left image and the grouped features of the right image under different parallaxes may be implemented by means of the following steps.

At step S2021a, the extracted features of the left image are grouped to form a first preset number of first feature groups.

At step S2021b, the extracted features of the right image are grouped to form a second preset number of second feature groups, where the first preset number is the same as the second preset number.

At step S2021c, a cross-correlation result of the g-th first feature group and the g-th second feature group under each of different parallaxes is determined, where g is a natural number greater than or equal to 1 and less than or equal to the first preset number. The different parallaxes include: a zero parallax, a maximum parallax, and any parallax between the zero parallax and the maximum parallax. The maximum parallax is a maximum parallax in the usage scenario corresponding to the image to be processed.

Here, the features of the left image are divided into a plurality of feature groups, and the features of the right image are also divided into a plurality of feature groups, and cross-correlation results of a certain feature group in the plurality of feature groups of the left image and the corresponding feature group of the right image under different parallaxes are determined. The group-wise cross-correlation refers to grouping the features of the left image (also grouping the features of the right image) after respectively obtaining the features of the left image and right image, and then performing the cross-correlation calculation on the corresponding groups (calculating the correlation thereof).

In some embodiments, the determining a cross-correlation result of the g-th first feature group and the g-th second feature group under each of different parallaxes includes: determining a cross-correlation result of the g-th first feature group and the g-th second feature group under each of different parallaxes using the formula

$${C}_{d}^{g} ( x , y ) = \frac{{N}_{g}}{{N}_{c}} sum \{ {f}_{l}^{g} ( x , y ) e {f}_{r}^{g} ( x + d , y ) \} ,$$

where N_{c} represents the number of channels of the features of the left image or the features of the right image, N_{g} represents a first preset number or a second preset number, fₗ^{g} represents features in the first feature group, fᵣ^{g} represents features in the second feature group, (x,y) represents a pixel coordinate of a pixel point whose horizontal ordinate is x and the vertical coordinate is y, and (x+d,y) represents a pixel coordinate of a pixel point whose horizontal ordinate is x+d and the vertical coordinate is y.

At step S203, the group-wise cross-correlation feature is determined as a 3D matching cost feature.

Here, for a certain pixel point, the parallax of the image is obtained by extracting the 3D matching feature of the pixel point under the parallax from 0 to ^{D}ₘₐₓ, determining the probability of each possible parallax, and performing weighted average on the probabilities, where Dₘₐₓ represents the maximum parallax in the usage scenario corresponding to the image to be processed. The parallax with the maximum probability in the possible parallaxes may also be determined as the parallax of the image.

At step S204, the depth of the image is determined by using the 3D matching cost feature.

In the embodiments of the present application, the accuracy of binocular matching is improved and the computing requirements of the network is reduced by obtaining an image to be processed, where the image is a 2D image including a left image and a right image; determining a group-wise cross-correlation feature by using the extracted features of the left image and the extracted features of the right image; determining the group-wise cross-correlation feature as the 3D matching cost feature; and determining the depth of the image by using the 3D matching cost feature.

Based on the foregoing method embodiments, embodiments of the present application further provide a binocular matching method. FIG. 2B is a schematic flowchart 2 of a binocular matching method according to the embodiments of the present application. As shown in FIG. 2B, the method includes the following steps.

At step S211, an image to be processed is obtained, where the image is a 2D image including a left image and a right image.

At step S212, a group-wise cross-correlation feature and a connection feature are determined by using extracted feature of the left image and extracted feature of the right image.

In the embodiments of the present application, the implementation method of the step S212 of determining a group-wise cross-correlation feature and a connection feature by using extracted feature of the left image and extracted feature of the right image is the same as the implementation method of step S202, and details are not described herein again.

At step S213, the feature obtained by concatenating the group-wise cross-correlation feature and the connection feature is determined as the 3D matching cost feature.

The connection feature is obtained by concatenating the features of the left image and the features of the right image in a feature dimension.

Here, the group-wise cross-correlation feature and the connection feature are concatenated in a feature dimension to obtain the 3D matching cost feature. The 3D matching cost feature is equivalent to obtaining one feature for each possible parallax. For example, if the maximum parallax is Dₘₐₓ, corresponding 2D features are obtained for possible parallaxes 0, 1, . . . , Dₘₐₓ−1, and the 2D features are concatenated into a 3D feature.

In some embodiments, a concatenation result of the features of the left image and the features of the right image to each possible parallax d is determined by using formula C_{d}(x,y)=Concat(fₗ(x, y), fᵣ(x+d, y)), to obtain Dₘₐₓ concatenation maps, where fₗ represents the features of the left image, fᵣ represents features of the right image, (x,y) is a pixel coordinate of a pixel point whose horizontal ordinate is x and the vertical coordinate is y, (x+d, y) represents a pixel coordinate of a pixel point whose horizontal ordinate is x+d and the vertical coordinate is y, and Concat represents concatenation two features; and then the Dₘₐₓ concatenation maps are concatenated to obtain a connection feature.

At step S214, the depth of the image is determined by using the 3D matching cost feature.

In the embodiments of the present application, the accuracy of binocular matching is improved and the computing requirements of the network is reduced by obtaining an image to be processed, where the image is a 2D image including a left image and a right image; determining a group-wise cross-correlation feature and a connection feature by using the extracted features of the left image and the extracted features of the right image; determining a feature formed by concatenating the group-wise cross-correlation feature and the connection feature as a 3D matching cost feature; and determining the depth of the image by using the 3D matching cost feature.

Based on the foregoing method embodiments, embodiments of the present application further provide a binocular matching method, including the following steps.

At step S221, an image to be processed is obtained, where the image is a 2D image including a left image and a right image.

At step S222, 2D features of the left image and 2D features of the right image are extracted respectively by using a full convolutional neural network sharing parameters.

In the embodiments of the present application, the full convolutional neural network is a constituent part of a binocular matching network. In the binocular matching network, 2D features of the image to be processed are extracted by using one full convolutional neural network.

At step S223, a 3D matching cost feature of the image is constructed by using extracted features of the left image and extracted features of the right image, where the 3D matching cost feature includes a group-wise cross-correlation feature, or includes a feature obtained by concatenating the group-wise cross-correlation feature and a connection feature.

At step S224, a probability of each of different parallaxes corresponding to each pixel point in the 3D matching cost feature is determined by using a 3D neural network.

In the embodiments of the present application, step S224 may be implemented by one classification neural network, which is also a constituent part of the binocular matching network, and is used to determine the probability of each of different parallaxes corresponding to each pixel point.

At step S225, a weighted mean of probabilities of respective different parallaxes corresponding to the pixel point is determined.

In some embodiments, a weighted mean of probabilities of respective different parallaxes d corresponding to each pixel point obtained may be determined by using formula

$$\tilde{d} = {\sum }_{d = 0}^{{D}_{m ax} - 1} d \cdot {p}_{d} ,$$

where each of the parallaxes d is a natural number greater than or equal to 0 and less than Dₘₐₓ, Dₘₐₓ is the maximum parallax in the usage scenario corresponding to the image to be processed, and P_{d} represents the probability corresponding to the parallax d.

At step S226, the weighted mean is determined as a parallax of the pixel point.

At step S227, the depth of the pixel point is determined according to the parallax of the pixel point.

In some embodiments, the method further includes: determining, by using formula D=FL/\tilde{d}, depth information D corresponding to the parallax \tilde{d} of the obtained pixel points, where F represents the lens focal length of a camera of the photographed sample, and L represents the lens baseline distance of the camera of the photographed sample.

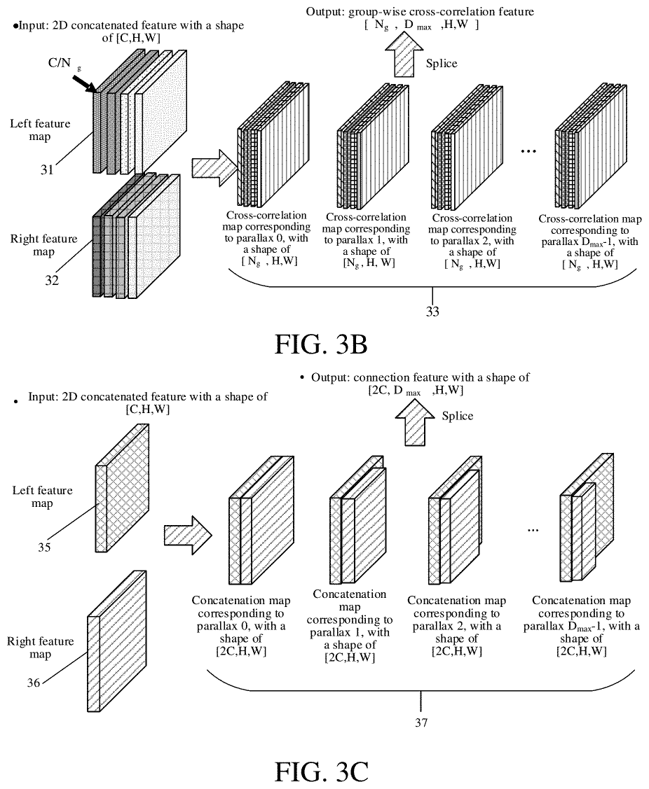

Based on the foregoing method embodiments, embodiments of the present application provide a training method for a binocular matching network. FIG. 3A is a schematic flowchart for implementing a training method for a binocular matching network according to embodiments of the present application. As shown in FIG. 3A, the method includes the following steps.

At step S301, a 3D matching cost feature of an obtained sample image is determined by using a binocular matching network, where the sample image includes left image and right image with depth annotation information, the left image and right image are the same in size; and the 3D matching cost feature includes a group-wise cross-correlation feature, or includes a feature obtained by concatenating the group-wise cross-correlation feature and a connection feature.

At step S302, a predicted parallax of the sample image is determined by using the binocular matching network according to the 3D matching cost feature.

At step S303, the depth annotation information is compared with the predicted parallax to obtain a loss function of binocular matching.

Here, parameters in the binocular matching network may be updated by means of the obtained loss function, and the binocular matching network after updating the parameters may predict a better effect.

At step S304, the binocular matching network is trained by using the loss function.

Based on the foregoing method embodiments, embodiments of the present application further provide a training method for a binocular matching network, including the following steps.

At step S311, 2D concatenated features of the left image and 2D concatenated features of the right image are determined respectively by a full convolutional neural network in the binocular matching network.

In the embodiments of the present application, the step S311 of determining 2D concatenated features of the left image and 2D concatenated features of the right image respectively by a full convolutional neural network in the binocular matching network may be implemented by means of the following steps.

At step S3111, a 2D feature of the left image and a 2D feature of the right image are extracting respectively by using the full convolutional neural network in the binocular matching network.

Here, the full convolutional neural network is a full convolutional neural network sharing parameters. Accordingly, the extracting, by the full convolutional neural network in the binocular matching network, 2D features of the left image and 2D features of the right image respectively includes: extracting, by the full convolutional neural network sharing parameters in the binocular matching network, the 2D features of the left image and the 2D features of the right image respectively, where the size of the 2D feature is a quarter of the size of the left image or the right image.

For example, if the size of the sample is 1200*400 pixels, then the size of the 2D feature is a quarter of the size of the sample, i.e., 300*100 pixels. Certainly, the size of the 2D feature may also be other sizes, which is not limited in the embodiments of the present application.

In the embodiments of the present application, the full convolutional neural network is a constituent part of a binocular matching network. In the binocular matching network, 2D features of the sample image are extracted by using one full convolutional neural network.

At step S3112, an identifier of a convolution layer for performing 2D feature concatenation is obtained.

Here, the determining an identifier of a convolution layer for performing 2D feature concatenation includes: determining the i-th convolution layer as a convolution layer for performing 2D feature concatenation when the interval rate of the i-th convolution layer changes, where i is a natural number greater than or equal to 1.

At step S3113, the 2D features of different convolution layers in the left image are concatenated in a feature dimension according to the identifier to obtain first 2D concatenated features.

For example, multi-level features are 64-dimension, 128-dimension, and 128-dimension (the dimension here refer to the number of channels) respectively, and then are connected to form a 320-dimensional feature map.

At step S3114, the 2D features of different convolution layers in the right image are concatenated in a feature dimension according to the identifier to obtain second 2D concatenated features.

At step S312, the 3D matching cost feature is constructed by using the 2D concatenated features of the left image and the 2D concatenated features of the right image.

At step S313, a predicted parallax of the sample image is determined by the binocular matching network according to the 3D matching cost feature.

At step S314, the depth annotation information is compared with the predicted parallax to obtain a loss function of binocular matching.

At step S315, the binocular matching network is trained by using the loss function.

Based on the foregoing method embodiments, embodiments of the present application further provide a training method for a binocular matching network, including the following steps.

At step S321, 2D concatenated features of the left image and 2D concatenated features of the right image are determined respectively by a full convolutional neural network in the binocular matching network.

At step S322, the group-wise cross-correlation feature is determined by using the obtained first 2D concatenated features and the obtained second 2D concatenated features.

In the embodiments of the present application, the step S322 of determining the group-wise cross-correlation feature by using the obtained first 2D concatenated features and the obtained second 2D concatenated features may be implemented by means of the following steps.

At step S3221, the obtained first 2D concatenated features are divided into N_{g} groups to obtain N_{g} first feature groups.

At step S3222, the obtained second 2D concatenated features are divided into N_{g} groups to obtain N_{g} second feature groups, N_{g} being a natural number greater than or equal to 1.

At step S3223, a cross-correlation result of each of the N_{g} first feature groups and a respective one of the N_{g} second feature groups under each parallax d is determined to obtain N_{g}*Dₘₐₓ cross-correlation maps, where the parallax d is a natural number greater than or equal to 0 and less than Dₘₐₓ, and Dₘₐₓ and is the maximum parallax in the usage scenario corresponding to the sample image.

In the embodiments of the present application, the determining a cross-correlation result of each of the N_{g} first feature groups and a respective one of the N_{g} second feature groups under each parallax d to obtain N_{g}*Dₘₐₓ cross-correlation maps includes: determining a cross-correlation result of the g-th first feature group and the g-th second feature group under each parallax d, to obtain Dₘₐₓ cross-correlation maps, where g is a natural number greater than or equal to 1 and less than or equal to N_{g}; and determining cross-correlation results of the N_{g} first feature groups and the N_{g} second feature groups under each parallax d, to obtain N_{g}*Dₘₐₓ cross-correlation maps.

Here, the determining a cross-correlation result of the g-th first feature group and the g-th second feature group under each parallax d, to obtain Dₘₐₓ cross-correlation maps includes: determining, by using formula

$${C}_{d}^{g} ( x , y ) = \frac{{N}_{g}}{{N}_{c}} sum \{ {f}_{l}^{g} ( x , y ) e {f}_{r}^{g} ( x + d , y ) \} ,$$

a cross-correlation result of the g-th first feature group and the g-th second feature group under each parallax d, to obtain Dₘₐₓ cross-correlation maps, where N_{c} represents the number of channels of the first 2D concatenated features or the second 2D concatenated features, fₗ^{g} represents features in the first feature group, fᵣ^{g} represents features in the second feature group, (x,y) represents a pixel coordinate of a pixel point whose horizontal coordinate is x and the vertical coordinate is y, and (x+d,y) represents a pixel coordinate of a pixel point whose horizontal coordinate is x+d and the vertical coordinate is y.

At step S3224, the N_{g}*Dₘₐₓ cross-correlation maps are concatenated in a feature dimension to obtain the group-wise cross-correlation feature.

Here, there are many usage scenarios, such as driving scenario, indoor robot scenario, and mobile phone dual-camera scenario, and the like.

At step S323, the group-wise cross-correlation feature is determined as a 3D matching cost feature.

FIG. 3B is a schematic diagram of a group-wise cross-correlation feature according to embodiments of the present application. As shown in FIG. 3B, the first 2D concatenated features of the left image are grouped to obtain a plurality of feature groups 31 of the left image after grouping. The second 2D concatenated features of the right image are grouped to obtain a plurality of feature groups 32 of the right image after grouping. The shape of the first 2D concatenated feature or the second 2D concatenated feature is [C, H, W], where C is the number of channels of the concatenated features, H is the height of the concatenated feature, and W is the width of the concatenated feature. Then, the number of channels of each feature group corresponding to the left or right image is C/N_{g}, and N_{g} is the number of groups. Cross-correlation calculation is performed on the feature groups corresponding to the left image and right image, and the cross-correlation of each corresponding feature group under the parallax of 0, 1, . . . , and Dₘₐₓ−1 is calculated to obtain N_{g}*Dₘₐₓ cross-correlation maps 33. The shape of each cross-correlation image 33 is [N_{g}, H, W], and the N_{g}*Dₘₐₓ cross-correlation images 33 are concatenated in a feature dimension to obtain a group-wise cross-correlation feature, and then the group-wise cross-correlation feature is used as a 3D matching cost feature, the shape of the 3D matching cost feature is [N_{g}, Dₘₐₓ, H, W], that is the shape of the group-wise cross-correlation feature is [N_{g}, Dₘₐₓ, H, W].

At step S324, a predicted parallax of the sample image is determined by using the binocular matching network according to the 3D matching cost feature.

At step S325, the depth annotation information is compared with the predicted parallax to obtain a loss function of binocular matching.

At step S326, the binocular matching network is trained by using the loss function.

Based on the foregoing method embodiments, embodiments of the present application further provide a training method for a binocular matching network, including the following steps.

At step S331, 2D concatenated features of the left image and 2D concatenated features of the right image are determined respectively by a full convolutional neural network in the binocular matching network.

At step S332, the group-wise cross-correlation feature is determined by using the obtained first 2D concatenated features and the obtained second 2D concatenated features.

In the embodiments of the present application, the implementation method of the step S332 of determining a group-wise cross-correlation feature by using the obtained first 2D concatenated feature and the obtained second 2D concatenated feature is the same as the implementation method of step S322, and details are not described herein again.

At step S333, the connection feature is determined by using the obtained first 2D concatenated feature and the obtained second 2D concatenated feature.

In the embodiments of the present application, the step S333 of determining the connection feature by using the obtained first 2D concatenated features and the obtained second 2D concatenated features may be implemented by means of the following steps.

At step S3331, a concatenation result of the obtained first 2D concatenated features and the obtained second 2D concatenated features under each parallax d is determined to obtain Dₘₐₓ concatenation maps, where the parallax d is a natural number greater than or equal to 0 and less than Dₘₐₓ, and Dₘₐₓ is the maximum parallax in the usage scenario corresponding to the sample image.

At step S3332, the Dₘₐₓ concatenation maps are concatenated to obtain the connection feature.

In some embodiments, a concatenation result of the obtained first 2D concatenated features and the obtained second 2D concatenated features under each parallax d is determined by using formula C_{d}(x,y)=Concat(fₗ(x,y),fᵣ(x+d, y)) to obtain Dₘₐₓ concatenation maps, where fₗ represents features in the first 2D concatenated features, fᵣ represents features in the second 2D concatenated features, (x,y) represents a pixel coordinate of a pixel point whose horizontal coordinate is x and the vertical coordinate is y, (x+d, y) represents a pixel coordinate of a pixel point whose horizontal coordinate is x+d and the vertical coordinate is y, and Concat represents concatenating two features.

FIG. 3C is a schematic diagram of a connection feature according to embodiments of the present application. As shown in FIG. 3C, the first 2D concatenated feature 35 corresponding to the left image and the second 2D concatenated feature 36 corresponding to the right image are connected at different parallaxes 0, 1, . . . , and Dₘₐₓ−1 to obtain D concatenation maps 37, and the Dₘₐₓ concatenation maps 37 are concatenated to obtain a connection feature. The shape of the 2D concatenated feature is [C, H, W], the shape of the single concatenation map 37 is [2C, H, W], the shape of the connection feature is [2C, Dₘₐₓ, H, W], C is the number of channels of the 2D concatenated feature, Dₘₐₓ is the maximum parallax in the usage scenario corresponding to the left or right image, H is the height of the left or right image, and W is the width of the left or right image.

At step S334, the group-wise cross-correlation feature and the connection feature are concatenated in a feature dimension to obtain the 3D matching cost feature.

For example, the shape of the group-wise cross-correlation feature is [N_{g}, Dₘₐₓ, H, W], and the shape of the connection feature is [2C, Dₘₐₓ, H, W], and the shape of the 3D matching cost feature is [N_{g}+2C, Dₘₐₓ, H, W].

At step S335, matching cost aggregation is performed on the 3D matching cost feature by using the binocular matching network.

Here, the performing, by the binocular matching network, the matching cost aggregation on the 3D matching cost feature includes: determining, by a 3D neural network in the binocular matching network, a probability of each different parallax d corresponding to each pixel point in the 3D matching cost feature, where the parallax d is a natural number greater than or equal to 0 and less than Dₘₐₓ, and Dₘₐₓ and is the maximum parallax in the usage scenario corresponding to the sample image.

In the embodiments of the present application, step S335 may be implemented by one classification neural network, which is also a constituent part of the binocular matching network, and is used to determine the probability of different parallaxes d corresponding to each pixel point.

At step S336, parallax regression is performed on the aggregated result to obtain the predicted parallax of the sample image.

Here, the performing parallax regression on the aggregated result to obtain the predicted parallax of the sample image includes: determining a weighted mean of probabilities of respective different parallaxes d corresponding to each pixel point as the predicted parallax of the pixel point, to obtain the predicted parallax of the sample image, where each of the parallaxes d is a natural number greater than or equal to 0 and less than Dₘₐₓ, and Dₘₐₓ is the maximum parallax in the usage scenario corresponding to the sample image.

In some embodiments, a weighted mean of probabilities of respective different parallaxes d corresponding to each pixel point obtained may be determined by using formula

$$\tilde{d} = {\sum }_{d = 0}^{{D}_{m ax} - 1} d \cdot {p}_{d} ,$$

where each of the parallaxes d is a natural number greater than or equal to 0 and less than Dₘₐₓ, Dₘₐₓ , is the maximum parallax in the usage scenario corresponding to the sample image, and P_{d} represents the probability corresponding under each parallax d.

At step S337, the depth annotation information is compared with the predicted parallax to obtain a loss function of binocular matching.

At step S338, the binocular matching network is trained by using the loss function.

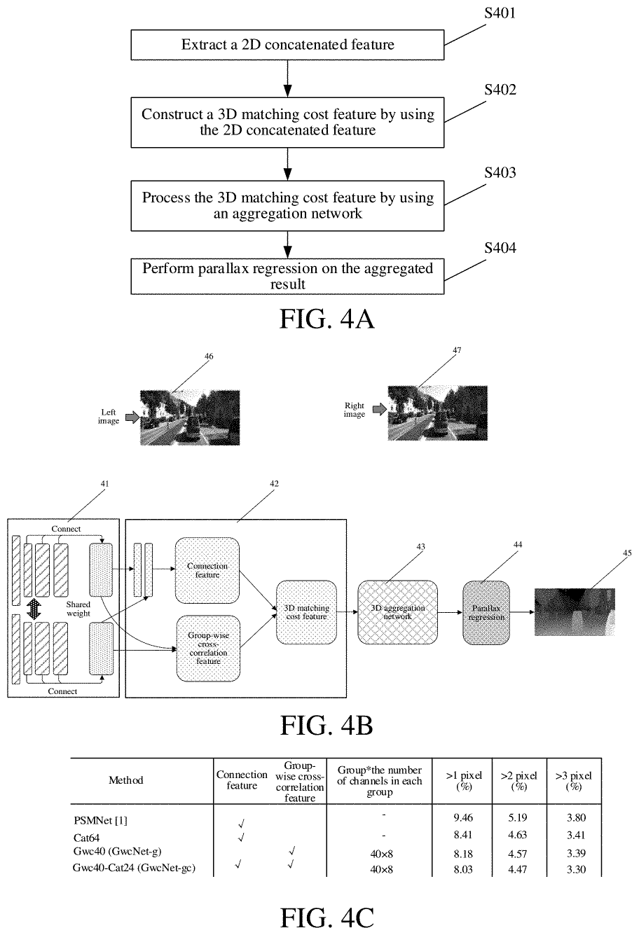

Based on the foregoing method embodiments, embodiments of the present application further provide a binocular matching method. FIG. 4A is a schematic flowchart 4 of a binocular matching method according to the embodiments of the present application. As shown in FIG. 4A, the method includes the following steps.

At step S401, a 2D concatenated feature is extracted.

At step S402, a 3D matching cost feature is constructed by using the 2D concatenated feature.

At step S403, the 3D matching cost feature is processed by using an aggregation network.

At step S404, parallax regression is performed on the aggregated result.

FIG. 4B is a schematic diagram of a binocular matching network model according to embodiments of the present application. As shown in FIG. 4B, the binocular matching network model may be roughly divided into four parts: a 2D concatenated feature extraction module 41, a 3D matching cost feature construction module 42, an aggregation network module 43, and a parallax regression module 44. The picture 46 and the picture 47 are left and right pictures in the sample data, respectively. The 2D concatenated feature extraction module 41 is configured to extract a 2D feature that is ¼ of the original image size by using a full convolutional neural network sharing parameters (including weight sharing) for the left and right pictures. The feature maps of different layers are connected into a large feature map. The 3D matching cost feature construction module 42 is configured to obtain a connection feature and a group-wise cross-correlation feature, and construct a feature map for all possible parallaxes d by using the connection feature and the group-wise cross-correlation feature to form a 3D matching cost feature. All possible parallaxes d include all parallaxes between the zero parallax and the maximum parallax, and the maximum parallax refers to the maximum parallax in the usage scenario corresponding to the left or right image. The aggregation network module 43 is configured to use a 3D neural network to estimate the probability of all possible parallaxes d. The parallax regression module 44 is configured to obtain a final parallax map 45 using the probabilities of all parallaxes.

In the embodiments of the present application, it is proposed that the old 3D matching cost feature is replaced by the 3D matching cost feature based on the group-wise cross-correlation operation. First, the obtained 2D concatenated features are grouped into N_{g} groups, and the g-th feature group corresponding to the left image and right image is selected (for example, when g=1, the first group of left image features and the first group of right image features are selected), and cross-correlation results of the feature groups under each parallax d are calculated. For each feature group g (0<=g<N_{g}) N_{g}*Dₘₐₓ cross-correlation maps may be obtained for each possible parallax d (0<=d<Dₘₐₓ). These results are connected and merged to obtain a group-wise cross-correlation feature with the shape of [N_{g}, Dₘₐₓ, H, W]. N_{g}, Dₘₐₓ, H and W are the number of feature groups, the maximum parallax of the feature map, the feature height and the feature width, respectively.

Then, the group-wise cross-correlation feature and the connection feature are combined as a 3D matching cost feature to achieve a better effect.

The present application provides a new binocular matching network based on a group-wise cross-correlation matching cost feature and an improved 3D stacked hourglass network, which may improve the matching accuracy while limiting the computational cost of the 3D aggregation network. The group-wise cross-correlation matching cost feature is directly constructed using high-dimensional features, which may obtain better representation features.

The network structure based on group-wise cross-correlation proposed in the present application consists of four parts, i.e., 2D feature extraction, construction of a 3D matching cost feature, 3D aggregation, and parallax regression.

The first step is 2D feature extraction, in which a network similar to a pyramid stereo matching network is used, and then the extracted final features of the second, third and fourth convolution layers are connected to form a 320-channel 2D feature map.

The 3D matching cost feature consists of two parts, i.e., a connection feature and a group-wise cross-correlation feature. The connection feature is the same as that in the pyramid stereo matching network, except that there are fewer channels than the pyramid stereo matching network. The extracted 2D features are first compressed into 12 channels by means of convolution, and then the parallax connections of the left and right features are performed on each possible parallax. The connection feature and the group-wise cross-correlation feature are concatenated together as an input to the 3D aggregation network.

The 3D aggregation network is used to aggregate features obtained from adjacent parallax and pixel prediction matching costs. It is formed by a pre-hourglass module and three stacked 3D hourglass networks to standardize the convolution features.

The pre-hourglass module and three stacked 3D hourglass networks are connected to the output module. For each output module, two 3D convolutions are used to output the 3D convolution feature of one channel, then the 3D convolution feature is upsampled and converted to probability along the parallax dimension by means of a softmax function.

The 2D features in the left image and the 2D features in the right image are represented by fₗ and fᵣ, N_{c} represents the channel, and the size of the 2D feature is ¼ of the original image. In the prior art, the left and right features are connected at different difference layers to form different matching costs, but the matching metrics need to be learned by using a 3D aggregation network, and need to be compressed to a small channel in order to save memory features before the connection. However, the representation of such a compressed feature may lose information. In order to solve the foregoing problem, the embodiments of the present application propose to establish a matching cost feature by using a conventional matching metric based on group-wise cross-correlation.

The basic idea of group-wise cross-correlation is to divide 2D features into a plurality of groups and calculate the cross-correlation of the corresponding groups in the left image and right image. In the embodiments of the present application, a group-wise cross-correlation is calculated by using formula

$${C}_{d}^{g} ( x , y ) = \frac{{N}_{g}}{{N}_{c}} sum \{ {f}_{l}^{g} ( x , y ) e {f}_{r}^{g} ( x + d , y ) \} ,$$

where N_{c} represents the number of channels of the 2D features, N_{g} represents the number of groups, fₗ^{g} represents the features in the feature group corresponding to the left image after the grouping, fᵣ^{g} represents the features in the feature group corresponding to the right image after the grouping, (x,y) represents a pixel coordinate of a pixel point whose horizontal ordinate is x and the vertical coordinate is y, (x+d, y) represents a pixel coordinate of a pixel point whose horizontal ordinate is x+d and the vertical coordinate is y, and e here represents the product of two features. Correlation refers to calculating the correlation of all feature groups g and all parallaxes d.

To further improve performance, the group-wise cross-correlation matching cost may be combined with the original connection features. The experimental results show that the grouping correlation features and the connection feature are complementary.

The present application improves the aggregation network in the pyramid stereo matching network. First, an additional auxiliary output module is added so that the additional auxiliary losses allow the network to learn better aggregation features of the lower layers, which is beneficial to the final prediction. Secondly, the remaining connection modules between different outputs are removed, thus saving computational costs.

In the embodiments of the present application, a loss function

$$L = {\sum }_{j = 0}^{j = 3} {λ}_{j} \cdot {Smooth}_{{L}_{j}} ( {\tilde{d}}_{j} - {d}^{*} )$$

is used to train a group-wise cross-correlation based network, where j represents that the group-wise cross-correlation based network used in the embodiments has three temporary results and one final result, λⱼ represents different results attached to different results, \tilde{d}ⱼ represents the parallax obtained using the group-wise cross-correlation based network, d* represents the true parallax, and Smooth_{L}_{ⱼ} is an existing loss function calculation method.

Here, the prediction error of the i-th pixel may be determined by formula eᵢ=|dᵢ−dᵢ*|, where dᵢ represents the predicted parallax of the i-th pixel point on the left or right image of the image to be processed determined by the binocular matching method provided by the embodiments of the present application, and dᵢ* represents the true parallax of the i-th pixel point.

FIG. 4C is a comparison diagram of experimental results of a binocular matching method according to embodiments of the present application and a binocular matching method in the prior art. As shown in FIG. 4C, the prior art includes PSMNet (i.e., a pyramid stereo matching network) and Cat64 (i.e., a method using the connection feature). Moreover, the the binocular matching method in the embodiments of the present application includes two types, the first one is Gwc40 (GwcNet-g) (i.e., a method based on a group-wise cross-correlation feature), and the second type is Gwc40-Cat24 (GwcNet-gc) (i.e., a method based on a feature formed by concatenating the group-wise cross-correlation feature and the connection feature). The two prior arts and the second method of the embodiments of the present application use the connection feature. However, only the embodiments of the present application use the group-wise cross-correlation feature. Furthermore, only the method in the embodiments of the present application involves feature grouping, that is, the obtained 2D concatenated features are divided into 40 groups, each group having eight channels. Finally, by using the image to be processed to test the prior art and the method in the embodiments of the present application, the percentage of an abnormal value of the stereo parallax may be obtained, which is a percentage of the abnormal value of more than one pixel, a percentage of the abnormal value of more than two pixels, and a percentage of the abnormal value of more than three pixels. It can be seen from the drawings that the experimental results obtained by two methods proposed in the present application are superior to the prior art, that is, the percentage of the abnormal value of the stereo parallax obtained by processing the image to be processed by using the method of the embodiments of the present application is less than the percentage of the abnormal value of the stereo parallax obtained by processing the image to be processed in the prior art.

Based on the foregoing embodiments, the embodiments of the present application provides a binocular matching apparatus, including various units, and various modules included in the units, which may be implemented by a processor in a computer device, and certainly may be implemented by a specific logic circuit. In the process of implementation, the processor may be a Central Processing Unit (CPU), a Micro Processing Unit (MPU), a Digital Signal Processor (DSP), a Field Programmable Gate Array (FPGA), etc.

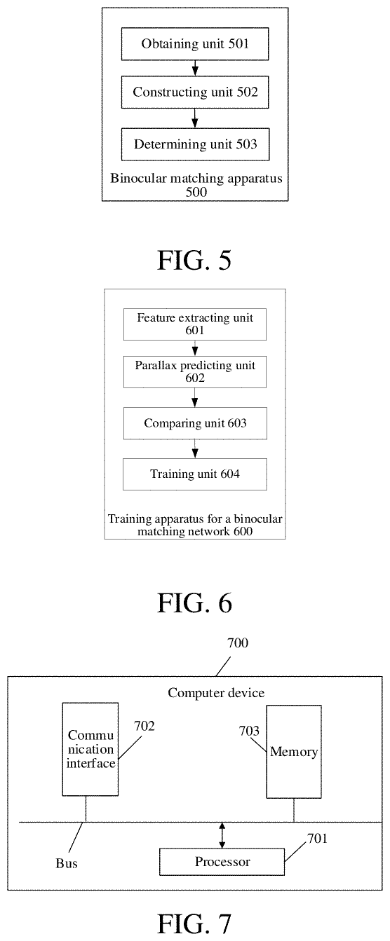

FIG. 5 is a schematic structural diagram of a binocular matching apparatus according to embodiments of the present application. As shown in FIG. 5, the apparatus 500 includes:

an obtaining unit 501, configured to obtain an image to be processed, where the image is a 2D image including a left image and a right image;

a constructing unit 502, configured to construct a 3D matching cost feature of the image by using extracted features of the left image and extracted features of the right image, where the 3D matching cost feature includes a group-wise cross-correlation feature, or includes a feature obtained by concatenating the group-wise cross-correlation feature and a connection feature; and

a determining unit 503, configured to determine the depth of the image by using the 3D matching cost feature.

In some embodiments, the constructing unit 502 includes:

a first constructing subunit, configured to determine the group-wise cross-correlation feature by using the extracted features of the left image and the extracted features of the right image; and
a second constructing subunit, configured to determine the group-wise cross-correlation feature as the 3D matching cost feature.

In some embodiments, the constructing unit 502 includes:

a first constructing subunit, configured to determine the group-wise cross-correlation feature and the connection feature by using the extracted features of the left image and the extracted features of the right image; and

a second constructing subunit, configured to determine the feature obtained by concatenating the group-wise cross-correlation feature and the connection feature as the 3D matching cost feature.

The connection feature is obtained by concatenating the features of the left image and the features of the right image in a feature dimension.

In some embodiments, the first constructing subunit includes:

a first constructing module, configured to respectively group the extracted features of the left image and the extracted features of the right image, and determine cross-correlation results of the grouped features of the left image and the grouped features of the right image under different parallaxes; and

a second constructing module, configured to concatenate the cross-correlation results to obtain a group-wise cross-correlation feature.

In some embodiments, the first constructing module includes:

a first constructing sub-module, configured to group the extracted features of the left image to form a first preset number of first feature groups;

a second constructing sub-module, configured to group the extracted features of the right image to form a second preset number of second feature groups, where the first preset number is the same as the second preset number; and

a third constructing sub-module, configured to determine a cross-correlation result of the g-th first feature group and the g-th second feature group under each of different parallaxes, where g is a natural number greater than or equal to 1 and less than or equal to the first preset number; the different parallaxes include: a zero parallax, a maximum parallax, and any parallax between the zero parallax and the maximum parallax; and the maximum parallax is a maximum parallax in the usage scenario corresponding to the image to be processed.

In some embodiments, the apparatus further includes:

an extracting unit, configured to extract 2D features of the left image and 2D features of the right image respectively by using a full convolutional neural network sharing parameters.

In some embodiments, the determining unit 503 includes:

a first determining subunit, configured to determine a probability of each of different parallaxes corresponding to each pixel point in the 3D matching cost feature by using a 3D neural network;

a second determining subunit, configured to determine a weighted mean of probabilities of respective different parallaxes corresponding to the pixel point;

a third determining subunit, configured to determine the weighted mean as a parallax of the pixel point; and

a fourth determining subunit, configured to determine the depth of the pixel point according to the parallax of the pixel point.

Based on the foregoing embodiments, embodiments of the present application provide a training apparatus for a binocular matching network. The apparatus includes including various units, and various modules included in the units, which may be implemented by a processor in a computer device, and certainly may be implemented by a specific logic circuit. In the process of implementation, the processor may be a CPU, a MPU, a DSP, an FPGA, etc.

FIG. 6 is a schematic structural diagram of a training apparatus for a binocular matching network according to embodiments of the present application. As shown in FIG. 6, the apparatus 600 includes:

a feature extracting unit 601, configured to determine a 3D matching cost feature of an obtained sample image by using a binocular matching network, where the sample image includes left image and right image with depth annotation information, the left image and right image are the same in size; and the 3D matching cost feature includes a group-wise cross-correlation feature, or includes a feature obtained by concatenating the group-wise cross-correlation feature and a connection feature;

a parallax predicting unit 602, configured to determine a predicted parallax of the sample image by using the binocular matching network according to the 3D matching cost feature;

a comparing unit 603, configured to compare the depth annotation information with the predicted parallax to obtain a loss function of binocular matching; and

a training unit 604, configured to train the binocular matching network by using the loss function.

In some embodiments, the feature extracting unit 601 includes:

a first feature extracting subunit, configured to determine 2D concatenated features of the left image and 2D concatenated features of the right image respectively by using a full convolutional neural network in the binocular matching network; and

a second feature extracting subunit, configured to construct the 3D matching cost feature by using the 2D concatenated features of the left image and the 2D concatenated features of the right image.

In some embodiments, the first feature extracting subunit includes:

a first feature extracting module, configured to extract 2D features of the left image and 2D features of the right image respectively by using the full convolutional neural network in the binocular matching network;

a second feature extracting module, configured to determine an identifier of a convolution layer for performing 2D feature concatenation;

a third feature extracting module, configured to concatenate the 2D features of different convolution layers in the left image in a feature dimension according to the identifier to obtain first 2D concatenated features; and

a fourth feature extracting module, configured to concatenate the 2D features of different convolution layers in the right image in a feature dimension according to the identifier to obtain second 2D concatenated features.

In some embodiments, the second feature extracting module is configured to determine the i-th convolution layer as a convolution layer for performing 2D feature concatenation when the interval rate of the i-th convolution layer changes, where i is a natural number greater than or equal to 1.

In some embodiments, the full convolutional neural network is a full convolutional neural network sharing parameters. Accordingly, the first feature extracting module is configured to extract the 2D features of the left image and the 2D features of the right image respectively by using the full convolutional neural network sharing parameters in the binocular matching network, where the size of the 2D feature is a quarter of the size of the left image or the right image.

In some embodiments, the second feature extracting subunit includes:

a first feature determining module, configured to determine the group-wise cross-correlation feature by using the obtained first 2D concatenated features and the obtained second 2D concatenated features; and

a second feature determining module, configured to determine the group-wise cross-correlation feature as the 3D matching cost feature.

In some embodiments, the second feature extracting subunit includes:

a first feature determining module, configured to determine the group-wise cross-correlation feature by using the obtained first 2D concatenated features and the obtained second 2D concatenated features;

the first feature determining module being further configured to determine the connection feature by using the obtained first 2D concatenated features and the obtained second 2D concatenated features; and

a second feature determining module, configured to concatenate the group-wise cross-correlation feature and the connection feature in a feature dimension to obtain the 3D matching cost feature.

In some embodiments, the first feature determining module includes:

a first feature determining sub-module, configured to divide the obtained first 2D concatenated features into N_{g} groups to obtain N_{g} first feature groups;

a second feature determining sub-module, configured to divide the obtained second 2D concatenated features into N_{g} groups to obtain N_{g} second feature groups, N_{g} being a natural number greater than or equal to 1;

a third feature determining sub-module, configured to determine cross-correlation results of the N_{g} first feature groups and the N_{g} second feature groups under each parallax d, to obtain N_{g}*Dₘₐₓ cross-correlation maps, where the parallax d is a natural number greater than or equal to 0 and less than Dₘₐₓ, and Dₘₐₓ is the maximum parallax in the usage scenario corresponding to the sample image; and

a fourth feature determining sub-module, configured to concatenate the N_{g}*Dₘₐₓ cross-correlation maps in a feature dimension to obtain the group-wise cross-correlation feature.

In some embodiments, the third feature determining sub-module is configured to determine a cross-correlation result of the g-th first feature group and the g-th second feature group under each parallax d, to obtain Dₘₐₓ cross-correlation maps, where g is a natural number greater than or equal to 1 and less than or equal to N_{g}; and determine cross-correlation results of the N_{g} first feature groups and the N_{g} second feature groups under each parallax d, to obtain N_{g}*Dₘₐₓ cross-correlation maps.

In some embodiments, the first feature determining module further includes:

a fifth feature determining sub-module, configured to determine a concatenation result of the obtained first 2D concatenated features and the obtained second 2D concatenated features under each parallax d, to obtain Dₘₐₓ concatenation maps, where the parallax d is a natural number greater than or equal to 0 and less than Dₘₐₓ, and Dₘₐₓ is the maximum parallax in the usage scenario corresponding to the sample image; and

a sixth feature determining sub-module, configured to concatenate the Dₘₐₓ concatenation maps to obtain the connection feature.

In some embodiments, the parallax predicting unit 602 includes:

a first parallax predicting subunit, configured to perform matching cost aggregation on the 3D matching cost feature by using the binocular matching network; and

a second parallax predicting subunit, configured to perform parallax regression on the aggregated result to obtain the predicted parallax of the sample image.

In some embodiments, the first parallax predicting subunit is configured to determine a probability of each different parallax d corresponding to each pixel point in the 3D matching cost feature by using a 3D neural network in the binocular matching network, where the parallax d is a natural number greater than or equal to 0 and less than Dₘₐₓ, and Dₘₐₓ is the maximum parallax in the usage scenario corresponding to the sample image.

In some embodiments, the second parallax predicting subunit is configured to determine a weighted mean of probabilities of respective different parallaxes d corresponding to each pixel point as the predicted parallax of the pixel point, to obtain the predicted parallax of the sample image.

Each of the parallaxes d is a natural number greater than or equal to 0 and less than Dₘₐₓ, and Dₘₐₓ is the maximum parallax in the usage scenario corresponding to the sample image.

The description of the foregoing apparatus embodiments is similar to the description of the foregoing method embodiments, and has similar advantages as the method embodiments. For the technical details that are not disclosed in the apparatus embodiments of the present application, please refer to the description of the method embodiments of the present application.

It should be noted that in the embodiments of the present application, when implemented in the form of a software functional module and sold or used as an independent product, the binocular matching method or the training method for a binocular matching network may also be stored in a computer readable storage medium. Based on such understanding, the technical solutions of the embodiments of the present application essentially, or the part contributing to the prior art may be implemented in the form of a software product. The computer software product is stored in a storage medium and includes several instructions for instructing a computer device (which may be a personal computer or a server, etc.) to perform all or some of the methods in the embodiments of the present application. The foregoing storage medium includes any medium that may store program codes, such as a USB flash drive, a removable hard disk, a Read-Only Memory (ROM), a magnetic disk, or an optical disk. In this case, the embodiments of the present application are not limited to any particular combination of hardware and software.

Accordingly, the embodiments of the present application provide a computer device, including a memory and a processor, where the memory stores a computer program running on the processor, where when the processor executes the program, steps of the binocular matching method in the foregoing embodiments are implemented, or steps of the training method for a binocular matching network in the foregoing embodiments are implemented.

Accordingly, the embodiments of the present application provide a computer readable storage medium having a computer program stored thereon, where when the computer program is executed by a processor, steps of the binocular matching method in the foregoing embodiments are implemented, or steps of the training method of a binocular matching network in the foregoing embodiments are implemented.

It should be noted here that the description of the foregoing storage medium and device embodiments is similar to the description of the foregoing method embodiments, and has similar advantages as the method embodiments. For the technical details that are not disclosed in the storage medium and apparatus embodiments of the present application, please refer to the description of the method embodiments of the present application.

It should be noted that FIG. 7 is a schematic diagram of a hardware entity of a computer device according to the embodiments of the present application. As shown in FIG. 7, the hardware entity of the computer device 700 includes: a processor 701, a communication interface 702, and a memory 703.

the processor 701 generally controls the overall operation of the computer device 700.

The communication interface 702 may enable the computer device to communicate with other terminals or servers over a network.

The memory 703 is configured to store instructions and applications executable by the processor 701, and may also cache data to be processed or processed by the processor 701 and each module of the computer device 700 (e.g., image data, audio data, voice communication data, and video communication data), which may be realized by a flash memory (FLASH) or Random Access Memory (RAM).

It should be understood that the phrase “one embodiment” or “an embodiment” mentioned in the description means that the particular features, structures, or characteristics relating to the embodiments are included in at least one embodiment of the present application. Therefore, the phrase “in one embodiment” or “in an embodiment” appeared in the entire description does not necessarily refer to the same embodiment. In addition, these particular features, structures, or characteristics may be combined in one or more embodiments in any suitable manner. It should be understood that, in the various embodiments of the present application, the size of the serial numbers in the foregoing processes does not mean the order of execution sequence. The execution sequence of each process should be determined by its function and internal logic, and is not intended to limit the implementation process of the embodiments of the present application. The serial numbers of the embodiments of the present application are merely for a descriptive purpose, and do not represent the advantages and disadvantages of the embodiments.

It should be noted that the term “comprising”, “including” or any other variant thereof herein is intended to encompass a non-exclusive inclusion, such that a process, method, article, or apparatus that includes a series of elements includes those elements. Moreover, other elements not explicitly listed are also included, or elements that are inherent to the process, method, article, or apparatus are also included. An element defined by the phrase “including one . . . ” does not exclude the presence of additional same elements in the process, method, article, or apparatus that includes the element, without more limitations.

In some embodiments provided by the present application, it should be understood that the disclosed device and method may be implemented in other manners. The device embodiments described above are merely illustrative. For example, the division of the unit is only a logical function division. In actual implementation, another division manner may be possible, for example, multiple units or components may be combined, or may be integrated into another system, or some features may be ignored or not executed. In addition, the coupling, or direct coupling, or communicational connection of the components shown or discussed may be indirect coupling or communicational connection by means of some interfaces, devices or units, and may be electrical, mechanical or other forms.

The units described as separate components may or may not be physically separate, and the components displayed as units may or may not be physical units, that is, may be located a same position, or may also be distributed to multiple network units. Some or all of the units may be selected according to actual requirements to achieve the objective of the solutions of embodiments.

In addition, functional units in the embodiments of the present application may be integrated into one processing unit, or may be used as one unit respectively, or two or more units may be integrated into one unit. The integrated unit may be implemented in the form of hardware or in the form of hardware plus software functional units.

A person of ordinary skill in the art may understand that all or some steps for implementing the foregoing method embodiments are achieved by a program by instructing related hardware; the foregoing program may be stored in a computer-readable storage medium; when the program is executed, steps including the foregoing method embodiments are executed. Moreover, the foregoing storage medium includes various media capable of storing program codes, such as ROM, RAM, a magnetic disk, or an optical disk.

Alternatively, when implemented in the form of a software functional module and sold or used as an independent product, the integrated unit of the present application may also be stored in a computer-readable storage medium. Based on such understanding, the technical solutions of the embodiments of the present application essentially, or the part contributing to the prior art may be implemented in the form of a software product. The computer software product is stored in a storage medium and includes several instructions for instructing a computer device (which may be a personal computer or a server, etc.) to perform all or some of the methods in the embodiments of the present application. Moreover, the foregoing storage media include various media capable of storing program codes such as a mobile storage device, an ROM, a magnetic disk, or an optical disk.

The above are only implementation modes of the present application, but the scope of protection of the present application is not limited thereto. Any person skilled in the art could easily conceive that changes or substitutions made within the technical scope disclosed in the present application should be included in the scope of protection of the present application. Therefore, the scope of protection of the present application should be determined by the scope of protection of the appended claims.

1. A binocular matching method, comprising:
obtaining an image to be processed, wherein the image is a two-dimensional (2D) image comprising a left image and a right image;
constructing a three-dimensional (3D) matching cost feature of the image by using extracted features of the left image and extracted features of the right image, wherein the 3D matching cost feature comprises a group-wise cross-correlation feature, or comprises a feature obtained by concatenating the group-wise cross-correlation feature and a connection feature; and
determining the depth of the image by using the 3D matching cost feature.

2. The method according to claim 1, wherein the constructing a 3D matching cost feature of the image by using extracted features of the left image and extracted features of the right image comprises:
determining the group-wise cross-correlation feature by using the extracted features of the left image and the extracted features of the right image; and determining the group-wise cross-correlation feature as the 3D matching cost feature; or
determining the group-wise cross-correlation feature and the connection feature by using the extracted features of the left image and the extracted features of the right image; and determining the feature obtained by concatenating the group-wise cross-correlation feature and the connection feature as the 3D matching cost feature; wherein the connection feature is obtained by concatenating the features of the left image and the features of the right image in a feature dimension.

3. The method according to claim 2, wherein the determining the group-wise cross-correlation feature by using the extracted features of the left image and the extracted features of the right image comprises:
grouping the extracted features of the left image and the extracted features of the right image respectively, and determining cross-correlation results of the grouped features of the left image and the grouped features of the right image under different parallaxes; and
concatenating the cross-correlation results to obtain a group-wise cross-correlation feature.

4. The method according to claim 3, wherein the grouping the extracted features of the left image and the extracted features of the right image respectively, and determining cross-correlation results of the grouped features of the left image and the grouped features of the right image under different parallaxes comprises:
grouping the extracted features of the left image to form a first preset number of first feature groups;
grouping the extracted features of the right image to form a second preset number of second feature groups, wherein the first preset number is the same as the second preset number; and
determining a cross-correlation result of the g-th first feature group and the g-th second feature group under each of the different parallaxes, wherein g is a natural number greater than or equal to 1 and less than or equal to the first preset number; the different parallaxes comprise: a zero parallax, a maximum parallax, and any parallax between the zero parallax and the maximum parallax; and the maximum parallax is a maximum parallax in the usage scenario corresponding to the image to be processed.

5. The method according to claim 1, wherein before the using the extracted features of the left image and the extracted features of the right image, the method further comprises:
extracting, by a full convolutional neural network sharing parameters, 2D features of the left image and 2D features of the right image respectively.

6. The method according to claim 5, wherein the determining the depth of the image by using the 3D matching cost feature comprises:
determining, by a 3D neural network, a probability of each of different parallaxes corresponding to each pixel point in the 3D matching cost feature;
determining a weighted mean of probabilities of the different parallaxes corresponding to the pixel point;
determining the weighted mean as a parallax of the pixel point; and
determining the depth of the pixel point according to the parallax of the pixel point.

7. A training method for a binocular matching network, comprising:
determining, by a binocular matching network, a 3D matching cost feature of an obtained sample image, wherein the sample image comprises left image and right image with depth annotation information, the left image and right image are the same in size; and the 3D matching cost feature comprises a group-wise cross-correlation feature, or comprises a feature obtained by concatenating the group-wise cross-correlation feature and a connection feature;
determining, by the binocular matching network, a predicted parallax of the sample image according to the 3D matching cost feature;
comparing the depth annotation information with the predicted parallax to obtain a loss function of binocular matching; and
training the binocular matching network by using the loss function.

8. The method according to claim 7, wherein the determining, by a binocular matching network, a 3D matching cost feature of an obtained sample image comprises:
determining, by a full convolutional neural network in the binocular matching network, 2D concatenated features of the left image and 2D concatenated features of the right image respectively; and
constructing the 3D matching cost feature by using the 2D concatenated features of the left image and the 2D concatenated features of the right image.

9. The method according to claim 8, wherein the determining, by a full convolutional neural network in the binocular matching network, 2D concatenated features of the left image and 2D concatenated features of the right image respectively comprises:
extracting, by the full convolutional neural network in the binocular matching network, 2D features of the left image and 2D features of the right image respectively;
determining an identifier of a convolution layer for performing 2D feature concatenation;
concatenating the 2D features of different convolution layers in the left image in a feature dimension according to the identifier to obtain first 2D concatenated features; and
concatenating the 2D features of different convolution layers in the right image in the feature dimension according to the identifier to obtain second 2D concatenated features.

10. The method according to claim 9, wherein the determining an identifier of a convolution layer for performing 2D feature concatenation comprises: determining the i-th convolution layer as a convolution layer for performing 2D feature concatenation when the interval rate of the i-th convolution layer changes, wherein i is a natural number greater than or equal to 1.

11. The method according to claim 9, wherein the full convolutional neural network is a full convolutional neural network sharing parameters;
the extracting, by the full convolutional neural network in the binocular matching network, 2D features of the left image and 2D features of the right image respectively comprises: extracting, by the full convolutional neural network sharing parameters in the binocular matching network, the 2D features of the left image and the 2D features of the right image respectively, wherein the size of the 2D feature is a quarter of the size of the left image or the right image.

12. The method according to claim 8, wherein the constructing the 3D matching cost feature by using the 2D concatenated features of the left image and the 2D concatenated features of the right image comprises:
determining the group-wise cross-correlation feature by using an obtained first 2D concatenated features and an obtained second 2D concatenated features; and determining the group-wise cross-correlation feature as the 3D matching cost feature; or
determining the group-wise cross-correlation feature by using the obtained first 2D concatenated features and the obtained second 2D concatenated features; determining the connection feature by using the obtained first 2D concatenated features and the obtained second 2D concatenated features; and concatenating the group-wise cross-correlation feature and the connection feature in a feature dimension to obtain the 3D matching cost feature.

13. The method according to claim 12, wherein the determining the group-wise cross-correlation feature by using the obtained first 2D concatenated features and the obtained second 2D concatenated features comprises:
dividing the obtained first 2D concatenated features into N_{g} groups to obtain N_{g} first feature groups;
dividing the obtained second 2D concatenated features into N_{g} groups to obtain N_{g} second feature groups N_{g} being a natural number greater than or equal to 1;
determining a cross-correlation result of each of the N_{g} first feature groups and a respective one of the N_{g} second feature groups under each parallax d, to obtain N_{g}*Dₘₐₓ cross-correlation maps, wherein the parallax d is a natural number greater than or equal to 0 and less than Dₘₐₓ, and Dₘₐₓ and is the maximum parallax in the usage scenario corresponding to the sample image; and
concatenating the N_{g}*Dₘₐₓ cross-correlation maps in a feature dimension to obtain the group-wise cross-correlation feature.

14. The method according to claim 13, wherein the determining a cross-correlation result of each of the N_{g} first feature groups and a respective one of the N_{g} second feature groups under each parallax d, to obtain N_{g}*Dₘₐₓ cross-correlation maps comprises:
determining a cross-correlation result of the g-th first feature group and the g-th second feature group under each parallax d, to obtain Dₘₐₓ cross-correlation maps, wherein g is a natural number greater than or equal to 1 and less than or equal to N_{g}; and
determining cross-correlation results of the N_{g} first feature groups and the N_{g} second feature groups under each parallax d, to obtain N_{g}*Dₘₐₓ cross-correlation maps.

15. The method according to claim 12, wherein the determining the connection feature by using the obtained first 2D concatenated features and the obtained second 2D concatenated features comprises:
determining a concatenation result of the obtained first 2D concatenated features and the obtained second 2D concatenated features under each parallax d, to obtain Dₘₐₓ concatenation maps, wherein the parallax d is a natural number greater than or equal to 0 and less than Dₘₐₓ, and Dₘₐₓ is the maximum parallax in the usage scenario corresponding to the sample image; and
concatenating the Dₘₐₓ concatenation maps to obtain the connection feature.

16. The method according to claim 7, wherein the determining, by the binocular matching network, a predicted parallax of the sample image according to the 3D matching cost feature comprises:
performing, by the binocular matching network, matching cost aggregation on the 3D matching cost feature; and
performing parallax regression on the aggregated result to obtain the predicted parallax of the sample image.

17. The method according to claim 16, wherein the performing, by the binocular matching network, matching cost aggregation on the 3D matching cost feature comprises:
determining, by a 3D neural network in the binocular matching network, a probability of each different parallax d corresponding to each pixel point in the 3D matching cost feature, wherein the parallax d is a natural number greater than or equal to 0 and less than Dₘₐₓ, and Dₘₐₓ is the maximum parallax in the usage scenario corresponding to the sample image.

18. The method according to claim 16, wherein the performing parallax regression on the aggregated result to obtain the predicted parallax of the sample image comprises:
determining a weighted mean of probabilities of respective different parallaxes d corresponding to each pixel point as the predicted parallax of the pixel point, to obtain the predicted parallax of the sample image;
wherein each of the parallaxes d is a natural number greater than or equal to 0 and less than Dₘₐₓ, and Dₘₐₓ the maximum parallax in the usage scenario corresponding to the sample image.

19. A binocular matching apparatus, comprising:
a processor; and
a memory, configured to store instructions which, when being executed by the processor, cause the processor to carry out the following:
obtaining an image to be processed, wherein the image is a two-dimensional (2D) image comprising a left image and a right image;
constructing a three-dimensional (3D) matching cost feature of the image by using extracted features of the left image and extracted features of the right image, wherein the 3D matching cost feature comprises a group-wise cross-correlation feature, or comprises a feature obtained by concatenating the group-wise cross-correlation feature and a connection feature; and
determining the depth of the image by using the 3D matching cost feature.

20. A non-transitory computer readable storage medium having stored thereon a computer program when being executed by a computer, cause the computer to carry out the binocular matching method according to claim 1.
